(19) United States
(12) Patent Application Publication
(10) Pub. No.: US 2025/0314943 A1
(43) Pub. Date: Oct. 9, 2025

(54) Wavelength Converter

(71) Applicant: Nippon Telegraph and Telephone Corporation, Tokyo (JP)

(72) Inventors: Nobutatsu Koshobu, Musashino-shi, Tokyo (JP); Takeshi Umeki, Musashino-shi, Tokyo (JP); Takahiro Kashiwazaki, Musashino-shi, Tokyo (JP)

(21) Appl. No.: 18/865,583

(22) PCT Filed: May 13, 2022
(86) PCT No.: PCT/JP2022/020283

§ 371 Date: Nov. 13, 2024

(51) Int. Cl. G02F 1/377; G02F 1/355

(52) U.S. Cl. CPC G02F 1/3775; G02F 1/3551; G02F 2202/20

(57) ABSTRACT

Provided is a wavelength converter that receives signal light and generates difference frequency light having a wavelength different from the signal light, the wavelength converter including: an optical waveguide core; a substrate having a refractive index lower than the optical waveguide core with respect to the signal light; a wavelength conversion element that converts the wavelength of the signal light; an overcladding formed on at least a part of a surface of the optical waveguide core and having a refractive index lower than the optical waveguide core with respect to optical wavelengths of the signal light and control light multiplexed with the signal light; and a temperature control element that controls a temperature of the wavelength conversion element.

### TECHNICAL FIELD

The present disclosure relates to a wavelength converter.

### BACKGROUND ART

Wavelength conversion technology has attracted attention in applications requiring light in a wavelength range that a semiconductor laser cannot directly output or high-output light that cannot be obtained by a semiconductor laser even in a wavelength range that the semiconductor layer can output. The wavelength converter is produced by using an optical crystal or the like having a second-order non-linear effect. Representative optical crystals include, for example, lithium niobate (LiNbO₃), potassium niobate (KNbO₃), lithium tantalate (LiTaO₃), or potassium titanate phosphate (KTiOPO₄). In particular, an optical waveguide using periodically poled lithium niobate (hereinafter referred to as PPLN) is an element capable of realizing an increase in light intensity and high wavelength conversion efficiency by use of a quasi-phase-matched technique. The PPLN is expected to be applied in a wide optical wavelength band from an ultraviolet range to a terahertz range, which is applied to optical signal wavelength conversion in optical communication, optical processing, medical care, biotechnology, and the like.

Further, the PPLN enables production of a parametric amplification element and an excitation light generation element constituting a phase sensitive amplifier (PSA) capable of low-noise light amplification. For this reason, the PPLN realizes high-gain and low-noise optical amplification characteristics, and is considered to be applied as a device that plays an important role in the next-generation optical fiber communication field. In addition, in the field of quantum computing, an optical waveguide using PPLN can be inserted into a fiber ring resonator and used as a parametric oscillation element. Regarding such a configuration, a report has been made that realizes an optical coherence imaging machine device and demonstrates a large-capacity calculation at a higher speed than a known computer. The above-described wavelength conversion element using an optical crystal such as LiNbO₃ is described in, for example, Patent Literature 1.

Patent Literature 1 discloses an example of producing a ridge-type optical waveguide. Patent Literature 1 describes, in order to improve a light confinement effect in a ridge-type optical waveguide, producing a wavelength conversion element by bonding a first substrate of a non-linear optical crystal having a periodically polarization-inverted structure and a second substrate having a refractive index smaller than the refractive index of the first substrate. In addition, Patent Literature 1 describes that a non-linear optical crystal of the same type as that of the first substrate is used as the second substrate, and the first substrate and the second substrate are diffusion-bonded by applying heat in order to avoid a crack due to deterioration of an adhesive or a temperature change. In order to further improve performance of these techniques, it is important to implement a wavelength converter having higher wavelength conversion efficiency.

### Citation List

### Patent Literature

Patent Literature 1: JP 3753236 B2

### SUMMARY OF INVENTION

However, the ridge-type optical waveguide as described in Patent Literature 1 has the following problems.

(a) Attachment of dust or the like, an increase in light loss, and a failure such as light burnout, due to exposure of an optical waveguide core
FIG. 1 illustrates a cross-sectional view of an optical waveguide core of a known wavelength conversion element. The known wavelength conversion element is conventionally a ridge-shaped optical waveguide in which an optical waveguide core 103 is formed on a substrate 101. Since the optical waveguide core 103 has a ridge shape, the surface thereof is exposed, and the atmosphere (air) is above the waveguide core 103 (in a direction opposite to the substrate 101). When signal light having low light intensity and control light having high light intensity propagate through the waveguide core, a part of an optical electric field leaks to the waveguide core surface. Therefore, attached matters such as dust and dirt that absorb light having a wavelength of the signal light or the control light are generated on the waveguide core surface. The attached matters absorb the light of the propagation light, and an increase in optical loss of the wavelength conversion element and a decrease in wavelength conversion efficiency occur.

(b) Damage to the bare optical waveguide core
In addition, the ridge-shaped optical waveguide core 103 may be easily damaged by being touched at the time of mounting the light conversion element. Furthermore, in the state where dust, dirt, or the like that absorbs light having the wavelength of the signal light or the control light is attached to the optical waveguide core 103, particularly in a case where the control light having high light intensity hits the attached matter such as dust or dirt attached to the core surface, very large heat generation occurs due to light absorption. At this time, when the dust as the attached matter on the core surface is burned and carbonized, the light absorption rate further increases, and thus very large local heat generation occurs. Such heat generation causes an increase in optical loss of the optical waveguide near the attached matter, heat generation of the optical waveguide core, and damage to the optical waveguide core due to stress of the attached matter.

(c) Decrease in thermal conductivity due to air cladding
The surface of the optical waveguide core 103 of the known wavelength conversion element is in contact with the atmosphere (air or the like). Heat conduction to the surface side above the core is caused by direct heat conduction from the substrate 101 side of the wavelength conversion element, heat radiation of infrared rays or the like, and heat conduction due to convection of the atmosphere (air or the like) to the surface of the waveguide core 103. In addition, main heat conduction is direct heat conduction from the substrate 101 side. Therefore, when viewed from the substrate 101 side, a portion of the ridge-shaped optical waveguide core 103 serves as a boundary with the atmosphere (air or the like) at an end of heat conduction. Therefore, a temperature gradient is likely to occur between the surface of the optical waveguide core 103 and the substrate 101 due to the influence of heat radiation, convection of outside air, or the like, which is a factor of deteriorating temperature controllability. Furthermore, the wavelength conversion efficiency of the wavelength conversion element 1 has temperature dependency, and it is necessary to control the temperature of the wavelength conversion element 1 in order to maximize the wavelength conversion efficiency. For this reason, the temperature controllability of the wavelength conversion element is important in order to quickly follow a change in environmental temperature.

(d) Generation of optical propagation loss by TE-TM conversion light
In the wavelength conversion element, it is favorable that an optical confinement mode at the time of light propagation of the signal light and excitation light is as single as possible. In addition, to satisfy a quasi-phase-matched condition, the optical confinement mode of propagating through the optical waveguide core is desirably single-mode propagation as much as possible. To reduce optical coupling loss of light input to and output from the optical wavelength conversion element at the time of direct optical coupling (butt joint optical coupling) using an optical fiber or optical coupling using a spatial optical system such as a lens, the single-mode propagation having a simple Gaussian distribution shape is more likely to obtain highly efficient optical connection. In addition, in a case of a plurality of multimode propagations in the optical waveguide, an effective refractive index in each mode slightly deviates, and the phase-matched condition at the time of wavelength conversion also deviates, so that the wavelength conversion element does not function as a highly efficient wavelength conversion element.

Furthermore, in the case of the wavelength conversion element having the ridge-shaped optical waveguide core formed on the substrate surface, overcladding has a low refractive index in the atmosphere (air). Therefore, an optical confinement effect of the optical waveguide core is large, and multimode propagation is likely to occur. For example, in the case of the wavelength conversion element in which an anomalous refractive axis of an optical non-linear crystal axis of the optical waveguide core is perpendicular to the substrate surface, cladding in a polarization direction horizontal to the substrate surface has an effective refractive index that is very small of about 1.0 with respect to the atmosphere (air). Therefore, the optical confinement effect in the polarization direction horizontal to the substrate surface becomes relatively very large, and propagation up to a high-order light mode becomes possible. Therefore, for example, even if the optical waveguide core is produced so as to propagate the signal light in a single mode in the polarization direction perpendicular to the substrate surface, a plurality of multimode optical propagations become possible even in the polarization direction horizontal to the substrate surface, and an optical propagation condition having a plurality of effective refractive indexes is provided.

At this time, in a case where the effective refractive index of the propagation mode light in the polarization direction perpendicular to the substrate and the effective refractive index of the propagation light mode in the polarization direction horizontal to the substrate have values very close to each other, material refractive index fluctuations of the optical waveguide core and structural fluctuations in core width and core thickness occur. At this time, the polarization direction rotates and so-called TE-TM polarization conversion of the propagation light occurs. When the TE-TM polarization conversion occurs, wavelength conversion light of polarized light necessary as output light cannot be obtained, and is output as completely different polarized light, or light energy is dissipated as multimode propagation light, and light energy loss such as light absorption occurs in optical spectrum measurement.

In a case where the band of a used light wavelength is narrow and limited, it is not impossible to design the optical waveguide core so that light absorption due to energy transition between waveguide modes such as TE-TM conversion does not occur, but this is a very problem when the wavelength conversion element is used in the entire range of a wide optical wavelength band. In addition, such TE-TM conversion is light energy transition of perturbation caused by overlap of the effective refractive indexes in the TE-TM polarization direction of the optical waveguide. Therefore, even in a wavelength conversion element called “type 1” in which the signal light and the excitation light have the same polarization direction or in a wavelength conversion element called “type 2” in which the signal light and the excitation light have perpendicular polarization directions, the TE-TM polarization conversion similarly occurs although optical polarization directions are different. Therefore, when producing a wavelength conversion element having a wide optical wavelength band, TE-TM conversion cannot be ignored regardless of the optical device structure of the wavelength conversion element.

To achieve the above object, a wavelength converter according to an aspect of the present disclosure is a wavelength converter that receives signal light and generates light having a wavelength different from a wavelength of the signal light, the wavelength converter including: a wavelength conversion element that includes an optical waveguide core and a substrate having a refractive index lower than the optical waveguide core with respect to the signal light and converts the wavelength of the signal light; an overcladding layer formed on at least a part of a surface of the optical waveguide core and having a refractive index lower than the optical waveguide core with respect to optical wavelengths of the signal light and control light multiplexed with the signal light; and a temperature control element that controls a temperature of the wavelength conversion element.

According to the above embodiment, it is possible to prevent the wavelength conversion element from adhering to the surface of the optical waveguide core, improve the temperature controllability, and widen the optical wavelength band for use. As a result, by reducing an influence from an outside of the wavelength conversion element, it is possible to reduce failure and provide a wavelength converter that can be used in a broad optical wavelength band.

### BRIEF DESCRIPTION OF DRAWINGS

FIG. 1 is a cross-sectional view of an optical waveguide core of a known wavelength conversion element.

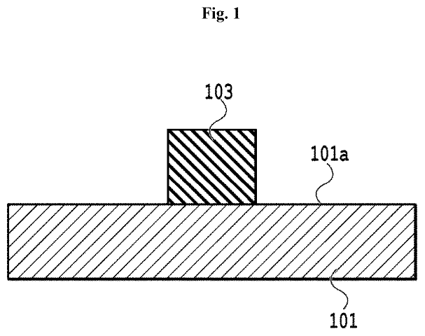

FIG. 2 is a perspective view illustrating a wavelength conversion element of the present embodiment.

FIG. 3 is a schematic cross-sectional view of an optical waveguide core illustrated in FIG. 2 cut in a direction orthogonal to an incident direction of signal light.

FIG. 4 is a view illustrating a configuration example of a wavelength converter in which a wavelength converter element of FIG. 3 is housed in a metal housing and a temperature control element is provided.

FIG. 5 is a configuration diagram of refractive index distribution of a cross section of an optical waveguide structure of Example 1.

FIG. 6 is a graph illustrating an effective refractive index of a propagation mode of each of TE polarization and TM polarization at an optical wavelength of 1400 nm to 1700 nm when an effective refractive index n_{OC} of overcladding is 1.0.

FIG. 7 is a graph illustrating the effective refractive index of the propagation mode of each of TE polarization and TM polarization at the optical wavelength of 1400 nm to 1700 nm when the effective refractive index n_{OC} of overcladding is 1.2.

FIG. 8 is a graph illustrating the effective refractive index of the propagation mode of each of TE polarization and TM polarization at the optical wavelength of 1400 nm to 1700 nm when the effective refractive index n_{OC} of overcladding is 1.4.

FIG. 9 is a graph illustrating the effective refractive index of the propagation mode of each of TE polarization and TM polarization at the optical wavelength of 1400 nm to 1700 nm when the effective refractive index n_{OC} of overcladding is 1.6.

FIG. 10 is a graph illustrating the effective refractive index of the propagation mode of each of TE polarization and TM polarization at the optical wavelength of 1400 nm to 1700 nm when the effective refractive index n_{OC} of overcladding is 1.8.

FIG. 11 is a graph illustrating the effective refractive index of the propagation mode of each of TE polarization and TM polarization at the optical wavelength of 1400 nm to 1700 nm when the effective refractive index n_{OC} of overcladding is 2.0.

FIG. 12 is a graph illustrating the effective refractive index of the propagation mode of each of TE polarization and TM polarization at the optical wavelength of 1400 nm to 1700 nm when the effective refractive index n_{OC} of overcladding is 2.1.

FIG. 13 is a graph illustrating a wavelength region having an intersection of a TM propagation 0th-order mode and a TE propagation mode, which are wavelengths at which a TE-TM conversion loss occurs.

### DESCRIPTION OF EMBODIMENTS

### Wavelength Conversion Device

Prior to describing an embodiment of the present disclosure, a wavelength converter will be described.

### Description of Second-Order Non-Linear Optical Effect and Phase-Matched Condition

In general, when signal light (signal light) [wavelength: λ1, frequency: ω1] and excitation light (pump light) [wavelength: λ2, frequency: ω2] having different wavelengths are incident on a second-order non-linear optical crystal, wavelength conversion light (also referred to as idler light) [wavelength: λ3, frequency: ω3] generates light having a wavelength according to a relationship called a phase-matched condition.

Consider a case of sum-frequency generation ω3=ω1+ω2. Since the momentum of a photon is expressed as hk/(2π) by the Planck constant h and an angular wave number k, when wave number mismatch is Δk, the following relationship is established from the momentum conservation law.

$$h Δ k / 2 π = h ( {k}_{3} - {k}_{1} - {k}_{2} ) / 2 π \qquad ( Equation 1 )$$

Thus, the following relationship is established.

$$Δ k = {k}_{3} - k 1 - {k}_{2} \qquad ( Equation 2 )$$

When a length of the second-order non-linear optical crystal through which light propagates is L and a propagation direction is a Z direction, a phase of non-linear polarization Pz(ω₁+ω₂) changes at exp[i(k₁+k₂)Z] but a phase of generated amplitude E(ω₃) is exp(ik₃*Z) and thus the following relationship is established between the two phases.

$$exp ( i {k}_{3} * Z ) - exp [ i ( {k}_{1} + {k}_{2} ) * Z ] = exp [ i ( {k}_{3} - {k}_{1} - {k}_{2} ) * Z ] = exp [ i Δ k * Z ] \qquad ( Equation 3 )$$

From the above description, that is, a phase difference of Δk*L occurs.

When the phase difference exceeds π, the phase is inverted, the direction of energy flow is reversed, and a process in which ω₃ photons are split into ω₁ and ω₂ occurs. In this way, an optical wave of a sum-frequency component created with effort turns to decrease.

Here, a distance at which the phase is inverted is referred to as a coherence length.

$$Lc = π / ( \vert Δ k \vert ) \qquad ( Equation 4 )$$

In addition, when this phase difference exceeds 2π (that is, a propagation length of light exceeds twice the coherence length), the direction in which energy flows returns to the original direction again, and it can be seen that the non-linear polarization Pz increases or decreases with a length twice the coherence length as a cycle (increase and decrease are interchanged for each coherence length). Therefore, to increase generation efficiency of wavelength conversion light, the coherence length at which attenuation starts needs to be longer than a crystal length to propagate. In particular, a condition Δk=0 in which the wavenumber mismatch is eliminated is called a phase-matched condition, and is a generation condition of the wavelength conversion light.

At this time, in a case where the two optical waves having the frequency ω1 and the frequency ω2 are input to a second-order non-linear material to generate light of ω₃(=ω₁+ω₂), as described above, it is called sum-frequency generation (SFG). On the other hand, in a case where two optical waves of frequencies ω₁ and ω₃ are input to the second-order non-linear material to generate light of ω₂(=ω₃−ω₁), it is called difference frequency generation (DFG).

In addition, a phenomenon in which light of the frequency ω₃ having high light intensity is incident and two optical waves of the frequency ω1 and the frequency ω2 are generated is called an optical parametric effect. Here, considering a case where all the optical waves to be combined travel in the same direction, the wavenumber mismatch Δk is expressed as follows.

$$Δ k = 2 π ( {n}_{3} / {λ}_{3} - {n}_{1} / {λ}_{1} - {n}_{2} / {λ}_{2} ) \qquad ( Equation 5 )$$

Therefore, the phase-matched condition is one of the following equations.

$${n}_{3} / {λ}_{3} = {n}_{1} / {λ}_{1} + {n}_{2} / {λ}_{2} \qquad ( Equation 6 )$$

$${ω}_{1} {n}_{1} + {ω}_{2} {n}_{2} = {ω}_{3} {n}_{3} \qquad ( Equation 7 )$$

In the above equations, n₁, n₂, and n₃ are refractive indexes of the second-order non-linear materials through which light beams having the respective wavelengths λ₁, λ₂, and λ₃ (frequencies: ω₁, ω₂, and ω₃) propagate. This means that, in Equation (7), a weighted average of n₁ and n₂ with the frequencies as weights is equal to n₃. In particular, in second harmonic generation, when polarization of fundamental wave photons to be combined is the same, the phase-matched condition is satisfied when the refractive indexes of the fundamental wave and a double wave are equal. However, in practice, since a substance always has refractive index wavelength dispersion, the phase-matched condition is not easily satisfied.

Therefore, in a uniform medium, (1) a method of utilizing refractive index dispersion by crystal orientation of a birefringent crystal (anisotropy with respect to linearly polarized light), (2) a method of utilizing refractive index dispersion by a rotatable substance (anisotropy with respect to circularly polarized light), (3) a method of utilizing anomalous dispersion associated with resonance, and the like have been studied.

(1) is easy to control by an angle or a temperature, and is most widely used. In the angle control, the phase-matched condition Δk=0 is realized by an angle matching method of non-parallel arrangement in which the propagation directions of the interacting optical waves are angled to satisfy the phase-matched condition in a vectorial manner, and the wavelength conversion light is generated. However, this angle matching method has a problem that a maximum non-linear constant of the non-linear optical crystal cannot be used. Meanwhile, in an optical waveguide, a photonic crystal, or the like that controls a propagation structure of light, there are structural dispersion depending on a dimension and a shape of a cross section and mode dispersion depending on a mode order in addition to material dispersion based on a refractive index, and thus, there is an advantage that a degree of freedom of phase speed control is remarkably increased.

### Description of Quasi-Phase-Matching

The above is a method of eliminating the wave number mismatch Δk=0, but instead, there is a quasi-phase-matched (hereinafter referred to as QPM) method of allowing the wave number mismatch and modulating non-linear susceptibility to cancel the effect of phase shift. This is an idea proposed by Armstrong et al., in 1962, which is a technique for achieving phase matching in a pseudo manner by a structure in which a sign of the non-linear susceptibility is periodically inverted. As described above, since the non-linear polarization increases or decreases with the length twice the coherence length as a cycle, the non-linear polarized waves generated from respective points are added together without canceling each other by setting the length twice the coherence length as a polarization inversion period (polarization inversion is performed at coherence length intervals), and an effect as if a phase mismatch amount is set to zero in a pseudo manner can be generated.

Assuming that the polarization inversion period is Λ, the following equation is obtained from the coherent length equation (Equation 4).

$$Λ = 2 * Lc \qquad ( Equation 8 )$$

Considering a case where all the optical waves to be combined travel in the same direction, the wave number mismatch is not zero as follows according to (Equation 4).

$$Δ k = 2 π ( {n}_{3} / {λ}_{3} - {n}_{1} / {λ}_{1} - {n}_{2} / {λ}_{2} ) = 2 π / Λ \qquad ( Equation 9 )$$

Thus, the following equation is obtained.

$${n}_{3} / {λ}_{3} - {n}_{2} / {λ}_{2} - {n}_{1} / {λ}_{1} - 1 / Λ = 0 \qquad ( Equation 10 )$$

(Equation 8) is the phase-matched condition of QPM. Here, n₃ is the refractive index at the wavelength λ₃, n₂ is the refractive index at the wavelength λ₂, and n₁ is the refractive index at the wavelength λ₁.

Unlike the above-described angle matching method, this QPM method has an advantage that the material orientation that becomes a maximum component of the non-linear susceptibility of the second-order non-linear crystal or the like can be used, and an operation wavelength range can be set by selecting an inversion period, and light can be densely confined in a narrow region and propagated over a long distance by forming an optical waveguide, so that highly efficient wavelength conversion has been achieved so far.

In addition, some methods of producing a wavelength conversion element using a quasi-phase-matched technique are also known. For example, there is a method of forming a crystal (hereinafter, referred to as a non-linear optical crystal) substrate that exhibits a non-linear optical effect to have a periodically polarization-inverted structure, and then producing a proton exchange waveguide using the periodically polarization-inverted structure. In addition, for example, similarly, there is a method of producing a ridge-type optical waveguide using a photolithography process and a dry etching process after forming the non-linear optical crystal substrate to have a periodically polarization-inverted structure.

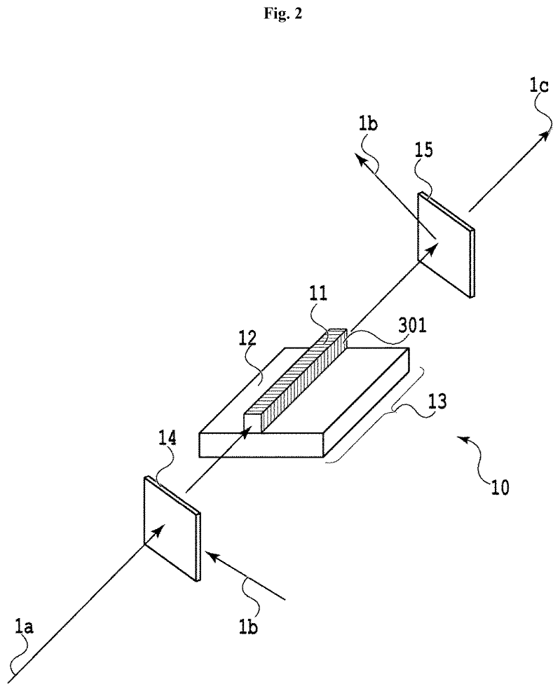

FIG. 2 is a perspective view illustrating a basic configuration 10 of the wavelength converter according to the embodiment of the present disclosure. The basic configuration 10 corresponds to the wavelength conversion element of the first embodiment. The basic configuration 10 illustrated in FIG. 2 is applied to a known wavelength converter that generates a difference frequency by QPM. Note that a known wavelength conversion element is disclosed in Patent Literature 1.

As illustrated in FIG. 2, signal light 1a having low light intensity and control light 1b having high light intensity are incident on a multiplexer 14 and multiplexed. The signal light 1a multiplexed with the control light 1b travels toward a substrate 12 and the wavelength conversion element including an optical waveguide core 11 disposed on the substrate 12. The light is incident on one end of the optical waveguide core 11 that has a periodically polarization-inverted structure and exhibits a non-linear optical effect. The signal light 1a is converted into difference frequency light 1c having a wavelength different from the signal light 1a when passing through the optical waveguide core 11 and is emitted from the other end of the optical waveguide core 11 together with the control light 1b. The difference frequency light 1c and the control light 1b emitted from the optical waveguide core 11 are incident on a demultiplexer 15 and demultiplexed from each other. The basic configuration 10 is a wavelength converter to which the signal light 1a is input and which generates light having a wavelength different from the signal light 1a. The basic configuration 10 is different from a known optical wavelength converter in that at least a part of the optical waveguide core 11 is provided with an overcladding 301 that is an overcladding layer having a refractive index lower than the optical waveguide core 11 with respect to the wavelengths of the signal light 1a and the control light 1b.

At this time, as the wavelength conversion element, SHG generation, optical parametric oscillation, and the like, using a wavelength conversion element having a QPM method, which has a periodically polarization-inverted structure in which the polarization direction of a ferroelectric crystal or a crystal lacking a center of symmetry, is periodically inverted by 180°, are used.

In general, the refractive index of the non-linear optical crystal has wavelength dispersion, and thus, the speed of the fundamental wave is not equal to the speed of the second harmonic, so that a phase difference occurs. For this reason, in the crystal, a synthetic wave of the second harmonic generated along an optical path exhibits a periodic function. The second harmonic generated at each point in the crystal propagates with a phase shifted between the harmonics, and the phase difference becomes π between the generated second harmonic and the second harmonic generated at a distance called a coherent length Lc. When the coherent length Lc is exceeded, the intensity of the synthetic harmonic decreases, and the increase and decrease are repeated in this period. Inverting the phase of a polarized wave generated from the optical non-linear material, that is, inverting a sign of a non-linear optical constant d, for each period, is QPM.

At this time, when a periodic polarization inversion period that is a QPM condition is matched with twice the coherent length Lc, the phase of the second harmonic is inverted and the phase of the synthetic second harmonic from the coherent length Lc is corrected. Therefore, the light intensity of the generated second harmonic is added without being dropped, amplitude (intensity) of the second harmonic is increased, and the second harmonic light is generated. These characteristics can use a maximum component of the non-linear optical constant, and can also be used for a crystal having a small birefringence index.

In addition, in the optical difference frequency generation, when n₃ of the wavelength conversion element is the refractive index at the wavelength λ₃, n₂ is the refractive index at the wavelength λ₂, n₁ is the refractive index at the wavelength λ₁, the polarization inversion period is Λ, and the coherent length is Lc, the optical non-linear polarized wave is amplified in the following equation, as described above.

$$Λ = 2 * Lc \qquad ( Equation 11 )$$

At this time, the QPM phase-matched condition is obtained as in (Equation 12) below.

$${n}_{3} / {λ}_{3} - {n}_{2} / {λ}_{2} - {n}_{1} / {λ}_{1} - 1 / Λ = 0 \qquad ( Equation 12 )$$

Here, n₃ is the refractive index at the wavelength λ₃, n₂ is the refractive index at the wavelength λ₂, and n₁ is the refractive index at the wavelength λ₁.

Unlike the above-described angle matching method, the QPM method can use the material orientation that becomes the maximum component of the non-linear susceptibility of the second-order non-linear crystal or the like. Further, the QPM method has an advantage that the operation wavelength range can be set by selecting an inversion period, and light can be densely confined in a narrow region and propagated over a long distance by forming an optical waveguide, so that highly efficient wavelength conversion has been achieved so far.

It is known that the basic configuration 10 illustrated in FIG. 2 is practically accommodated together with a multiplexer and a demultiplexer in a metal housing including an input/output port capable of inputting and outputting light so as not to deteriorate characteristics due to a change in a use environment to constitute a light converter. Furthermore, the wavelength conversion efficiency of the wavelength conversion element has temperature dependency, and it is necessary to control a temperature of the wavelength conversion element in order to maximize the wavelength conversion efficiency.

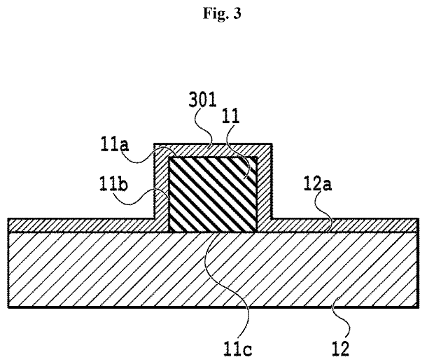

FIG. 3 is a schematic cross-sectional view of the optical waveguide core 11 illustrated in FIG. 2 cut in the direction orthogonal to the incident direction of the signal light 1a. As described above, in the present embodiment, the overcladding 301 is provided in at least a part of the optical waveguide core 11. The overcladding 301 is a layer having a refractive index lower than the optical waveguide core 11 with respect to the signal light 1a and the control light 1b, and enables optical confinement of the optical waveguide core 11.

The configuration illustrated in FIG. 3 includes the substrate 12, the optical waveguide core 11 formed on the substrate 12, and the overcladding 301 formed on an upper surface 12a of the substrate 12 and a part of a surface of the optical waveguide core 11. The refractive index with respect to the signal light 1a, of the substrate 12, is lower than that of the optical waveguide core 11. The overcladding 301 illustrated in FIG. 3 is formed on the upper surface 12a of the substrate 12, an upper surface 11a and a side surface 11b of the optical waveguide core 11, and is not formed on a cross section 11c. This is to prevent deterioration in permeability of the signal light 1a and the control light 1b to the optical waveguide core 11.

The overcladding 301 does not need to have the structure of covering the entire upper surface 12a of the substrate 12 as illustrated in FIG. 3, and may have a structure of covering the surface except for a surface that the ridge-shaped optical waveguide core 11 allows incidence or emission. Furthermore, the present embodiment may be formed so as to cover a part of the ridge-shaped side surface in accordance with specification and application states of the basic configuration 10. The film thickness of the overcladding 301 may be 0.5 microns or more, but is desirably 1 micron or more in order to completely keep the leaked electric field of propagation light.

When the leakage of the optical electric field to the surface of the ridge-shaped optical waveguide core is reduced to a negligible extent by the overcladding 301, even if dust or the like is attached to the surface of the overcladding 301, it is possible to reduce a situation of an increase in light loss generated by propagation of high-intensity light or burning of the attached matter such as dust or the like.

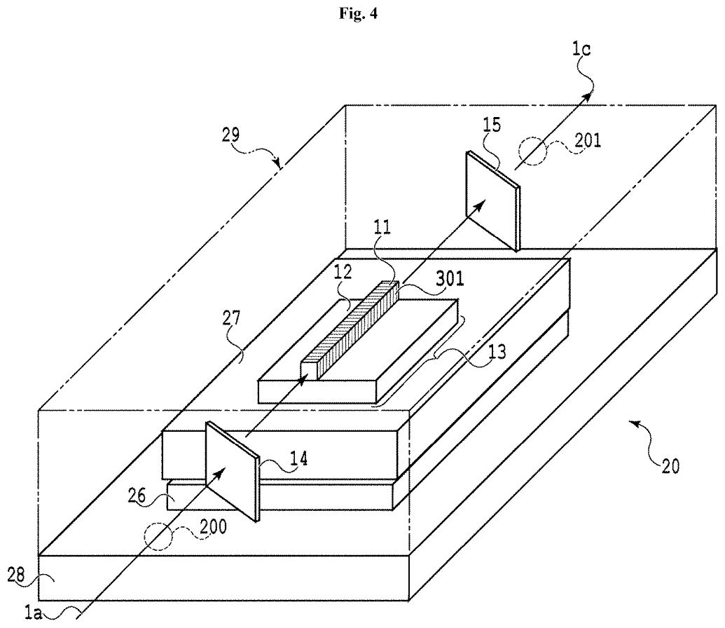

FIG. 4 is a view illustrating a configuration example of a wavelength converter 20 further including a metal housing bottom surface member 28, a cover member 29, and a temperature control element 26 in addition to the configuration of the basic configuration 10 of FIG. 3. The metal housing bottom surface member 28 and the cover member 29 constitute the metal housing. The metal housing is provided with an input port 200 and an output port 201 of light. The wavelength converter 20 illustrated in FIG. 4 further includes a support member 27 that supports the temperature control element 26. The support member 27 is a metal member for uniformly controlling the temperature of the entire wavelength conversion element 13 including the optical waveguide core 11 and the substrate 12. The temperature control element 26 is interposed between the support member 27 and the metal housing bottom surface member 28, and is bonded and fixed by a bonding member (not illustrated) that conducts heat between the temperature control element 26 and the support member 27, and the metal housing bottom surface member 28, and is less likely to change the fixed position. Note that the optical waveguide core 11, the substrate 12, the wavelength conversion element 13, the multiplexer 14, the demultiplexer 15, the signal light 1a, and the difference frequency light 1c are the same as those in the description of FIG. 2, and thus description thereof is omitted.

In addition, in a case where a wavelength conversion element using a ferroelectric crystal material is used in the wavelength converter, a phenomenon called light damage occurs in which the refractive index of the wavelength conversion element is changed by irradiation of light having a short wavelength, and characteristics are deteriorated. As a method for preventing an influence of the light damage, it has been proposed to use the wavelength conversion element at a high temperature. Therefore, in the first embodiment, the wavelength converter 20 is provided with the temperature control element 26, and the temperature control element 26 operates the wavelength conversion element 13 in an environment of a temperature range from about 20° C. or higher near room temperature to an extent that dew condensation does not practically occur to about 100° C. or lower in which an adhesive does not deteriorate.

Note that, in the present embodiment, there is no limitation on the refractive index as long as it is only necessary to prevent adhesion of the attached matter such as dust to the surface of the optical waveguide core 11. However, actually, it is necessary to propagate the signal light 1a and the control light 1b through the optical waveguide core 11. Therefore, to confine the light in the signal light and the optical wavelength of control, the overcladding 301 having the refractive index lower than the optical waveguide core 11 is desirable. In addition, since the light leakage of the signal light and the control light from the optical waveguide core to the overcladding occurs, the overcladding is desirably made of a material having excellent optical transparency in the optical wavelength of the signal light and the control light.

Here, reduction of TE-TM optical coupling by limiting a refractive index range of the overcladding and widening of a used optical band will be described. In particular, in a case where a non-linear crystal is used as the optical waveguide core of the wavelength conversion element, in general, the refractive indexes of both of TE polarization and TM polarization of the optical waveguide core are sufficiently larger than the refractive index of air of about 1.0. Therefore, since a relative refractive index of optical confinement in the TE polarization parallel to the substrate increases, a propagation mode in the TE polarization is easily multimode, and the optical confinement mode of the TE polarization with a very large number of effective refractive indexes can propagate light. Therefore, even if a TM polarization mode is designed to be close to the propagation mode of the signal light or the excitation light and the single mode (0th-order mode), the propagation mode light of the TE polarization equal to the effective refractive index of the TM polarization can exist.

Therefore, the optical loss of the TM polarization caused by the TE-TM polarization conversion is likely to occur due to fluctuations in the refractive index and structure of the optical waveguide. Therefore, not only the refractive index of the overcladding in the TM polarization is brought close to the optical waveguide core, but also the refractive index of the TE polarization is brought close to the optical waveguide core, so that the number of propagation modes in the TE polarization is reduced, whereby the optical loss of the TE-TM polarization conversion can be reduced, and the optical wavelength can be widened. To realize such a configuration, the refractive index of the overcladding is desirably a refractive index lower by 0% to 25% than the refractive index of the optical waveguide core. More specifically, the refractive index of the overcladding is desirably within a range smaller by 0% or more and 6% or less than the refractive index of the optical waveguide core. Note that the refractive index referred to here is a refractive index of the signal light and the control light with respect to the overcladding, or a refractive index of the signal light and the control light with respect to the optical waveguide core. The “refractive index lower by 0% than that of the optical waveguide core” refers to that the refractive index is equal to that of the optical waveguide core.

Next, the material of the overcladding will be described. As the overcladding material, a material that hardly deteriorates with respect to the optical wavelength for use is desirable because the signal light and the excitation light having high light intensity are made incident in the optical waveguide core of the wavelength conversion element. Further, since the overcladding is formed adjacent to the optical waveguide core, a material having a linear thermal expansion coefficient close to the optical waveguide core is desirable, and an inorganic material similar to the optical non-linear crystal material used for the optical waveguide core, specifically, lithium niobate (LiNbO₃), potassium niobate (KNbO₃), lithium tantalate (LiTaO₃), lithium tantalate having a non-stoichiometric composition (LiNb(x)Ta(1−x)O₃(0≤x≤1)), or potassium phosphate titanate (KTiOPO₄) is desirable. Further, an inorganic material containing zirconium (Zr), magnesium (Mg), zinc (Zn), scandium (Sc), indium (In), or containing at least one oxide selected from zirconium (Zr), niobium (Nb), tantalum (Ta), hafnium (Hf), magnesium (Mg), zinc (Zn), scandium (Sc), titanium (Ti), yttrium (Y), aluminum (Al), indium (In), or silicon (Si) is desirable.

In addition, in a case of using an optical non-linear crystal or the like as the inorganic material, the optical waveguide core may have a relatively large linear thermal expansion coefficient of 10 ppm or more, depending on the material of the optical waveguide core. In that case, an organic material having a relatively large linear thermal expansion coefficient can also be used. More specifically, there are: polyolefins such as polyethylene, polypropylene, and polybutylene, polydienes such as polybutadiene and natural rubber, vinyl polymers such as polystyrenes, polyvinyl acetates, polymethyl vinyl ether, polyethyl vinyl ether, polyacrylic acid, polymethyl acrylate, polymethacrylic acid, polymethyl methacrylate, polybutyl methacrylate, polyhexyl methacrylate, and polydodecyl methacrylate, linear olefin-based polyethers, polyphenylene oxide (PPO), and copolymers and blends thereof, polyethersulfone (PES) in which an ether group and a sulfone group are mixed, polyetherketone (PEK) in which an ether group and a carbonyl group are mixed, polyethers such as polyphenylene sulfide (PPS) and polysulfone (PSO) having a thioether group, and copolymers and blends thereof, polyolefins having at least one substituent such as an OH group, a thiol group, a carbonyl group, or a halogen group at the terminal, examples thereof including HO—(C—C—C—C—)n-(C—C—(C—C—)m)—OH, polyoxides such as polyethylene oxide and polypropylene oxide, polymer materials such as polybutyl isocyanate and polyvinylidene fluoride, further, epoxy resins, and crosslinked products by oligomers and curing agents. Furthermore, a mixture obtained by mixing two or more of these materials may be used.

In addition, polysiloxane or a crosslinked product of polysiloxane (commonly referred to as silicone resin) may be used. This material has not only a large temperature coefficient of the refractive index but also excellent water resistance and long-term stability, and is most suitable as a light intensity compensation material of the present invention.

Polysiloxane is represented by the following general formula.

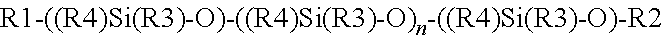

In the above formula, R1 and R2 at both left and right ends represent terminal groups, and include any of hydrogen, an alkyl group, a hydroxyl group, a vinyl group, an amino group, an aminoalkyl group, an epoxy group, an alkyl epoxy group, an alkoxy epoxy group, a methacrylate group, a chlor group, and an acetoxy group.

R3 and R4 of the siloxane bond represent side chain groups, and include hydrogen, an alkyl group, an alkoxy group, a hydroxyl group, a vinyl group, an amino group, an aminoalkyl group, an epoxy group, a methacrylate group, a chloro group, an acetoxy group, a phenyl group, a fluoroalkyl group, an alkylphenyl group, and a cyclohexane group. The polysiloxane to be mounted may be one kind or a mixture of a plurality of kinds.

Meanwhile, the crosslinked product of polysiloxane is obtained by causing a reactive polysiloxane having a vinyl group, hydrogen, a silanol group, an amino group, an epoxy group, or a carbinol group as a terminal group to react with polysiloxane in the presence of a platinum catalyst, a radical, an acid, a base, or the like. In addition, it is also possible to use a product in which polysiloxane to be mounted is formed into a soft gel, a composite in which low-molecular-weight polysiloxane is contained in gel-like polysiloxane, or a product in which high-molecular-weight polysiloxane and low-molecular-weight polysiloxane are mixed and subjected to a crosslinking reaction.

Next, a method of producing the above-described light conversion element will be described.

First, a method of producing the optical waveguide core illustrated in FIG. 2 and the like will be described. As a method of manufacturing the wavelength conversion element, first, a metal electrode film for producing the periodically polarization-inverted structure that satisfies the quasi-phase-matched condition is produced using a photolithography method at a desired position of a wafer substrate produced using a non-linear optical crystal that is a wavelength conversion material, periodically polarization inversion is formed by applying a high DC electric field, and a metal electrode film and an insulating film are removed to produce a wafer for optical waveguide core.

Next, the wafer for optical waveguide is bonded onto the substrate using a surface activation method by plasma discharge or a thermal bonding method, and then ground and polished to have a desired film thickness, thereby being processed to have a desired core thickness. Further, a pattern of the optical waveguide core made of a photoresist material is formed on a surface of an optical waveguide core layer on the substrate, the core layer is processed into the optical waveguide core having a desired ridge shape by a dry etching method under vacuum using Ar plasma or the like, and a resist residue or the like on the surface of the optical waveguide core is cleaned and removed by piranha cleaning or the like.

Next, a method of producing the overcladding formed on the surface of the optical waveguide core in the present embodiment will be described. Thereafter, in the present embodiment, the overcladding is formed on the surface of the optical waveguide core of the ridge-shaped wavelength conversion element. As a method of forming the overcladding, a solvent dilution method, or a sputtering method, a chemical vapor deposition method (CVD) in an empty environment, or a vacuum vapor deposition method can be used for an unliquefied material, or a spin coating method in a solution state, a casting method, or the like can also be used for a material that can be dissolved in a solvent or a material that can be non-fluidized by heat melting or a chemical reaction.

### EXAMPLES

Hereinafter, the present disclosure will be described more specifically with reference to examples, but the present disclosure is not limited to these examples.

### Example 1

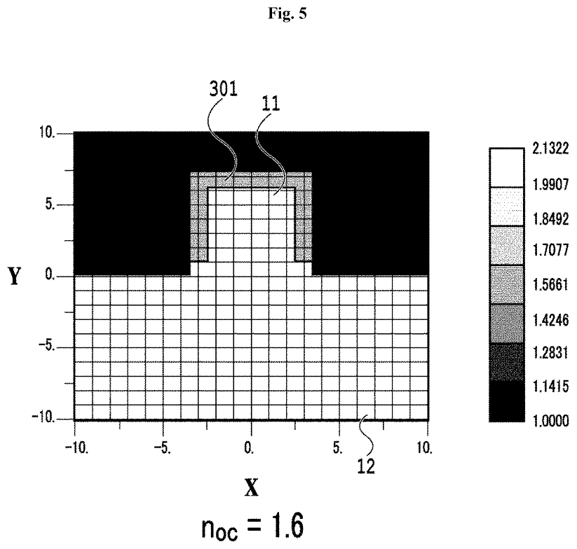

FIG. 5 illustrates a configuration diagram of a refractive index distribution of a cross section of the optical waveguide structure used in Example 1 of the present invention. FIG. 5 illustrates a configuration diagram of a refractive index distribution of a cross section of the optical waveguide structure in the case where the effective refractive index n_{OC} of the overcladding is 1.6 in order to facilitate understanding of the structure and the refractive index of the overcladding. FIG. 5 illustrates the refractive index of the cross section of the optical waveguide core by gradation of an image. The relationship between the refractive index and the gradation is indicated by the bar on the right side in the drawing.

In the wavelength converter of the present example, in order to verify whether TE-TM conversion occurs in 460 nm to 1530 nm of a short-wavelength-band (S band), 1530 nm to 1565 nm of a conventional-band (C band), and 1565 nm to 1625 nm of a long-wavelength-band (L band) of the optical communication wavelength as the signal light, a light propagation mode in each of TE and TM modes in a wide band of the optical wavelength of 1400 nm to 1700 nm was analyzed, and the wavelength band in which the TE-TM mode conversion loss occurs was estimated.

As an analysis method for the light propagation mode, Mode Solver of BPM-CAD by OptiWave was used, and analysis was performed using a finite element method. As a cross-sectional structure of the optical waveguide, the optical waveguide core 11 illustrated in FIG. 5 was made of LiNbO₃(LN), Z cut of the crystal axis having abnormal refraction in the direction perpendicular to the substrate surface was performed, a core width of 5.3 μm and a core thickness of 5.0 μm was obtained. The substrate 12 was made of an LN crystal using LiTaO₃(LT), and the optical waveguide core was set to be separated from the substrate 12 by a height of 1.0 μm with the same width as the core width of 5.3 μm in order to reduce the influence of the refractive index of the adjacent substrate, and a convex rib structure was formed on the surface of the substrate 12. In the present example, the core width and the core thickness are set so that signal light in the TM polarization can be propagated in the single mode, and can be produced even if the core width is not 5.3 μm and the core thickness is not 5.0 μm. The overcladding 301 having the film thickness of 1.0 μm was formed on the surface of the optical waveguide core 11, the surface of the substrate 12 and a region around the overcladding 301 were assumed to be the atmosphere (vacuum), and the refractive index was assumed to be 1.0.

In addition, in the cross-sectional structure of the optical waveguide of the present example, the effective refractive index n_{OC}=1.0 of the overcladding 301 was changed to n_{OC}=2.1 adjacent to the refractive index in the TM direction (Z-axis direction) of the optical waveguide core, the propagation mode in the range of the optical wavelength from 1400 to 1700 nm was calculated, and the wavelength dependency of the effective refractive index was calculated. At this time, the wavelength conversion element of the type 1 in which the polarization directions of the signal light and the excitation light are the same was assumed, and the TM polarization mode perpendicular to the substrate surface and the TE polarization mode parallel to the substrate were analyzed. Since the TE-TM polarization conversion occurs when the signal light and the excitation light propagated by the TM polarization have the same value as the effective refractive index of the TE polarization mode, the optical wavelength thereof was obtained.

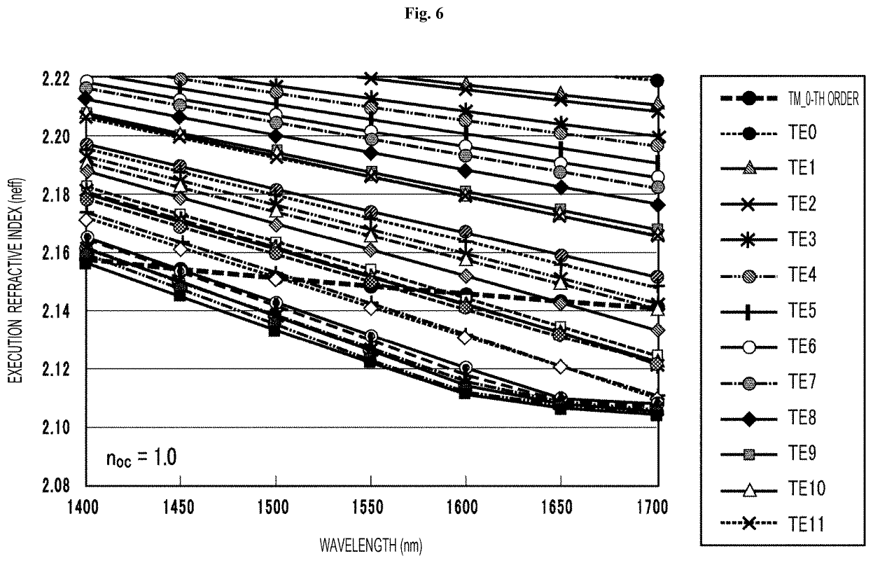

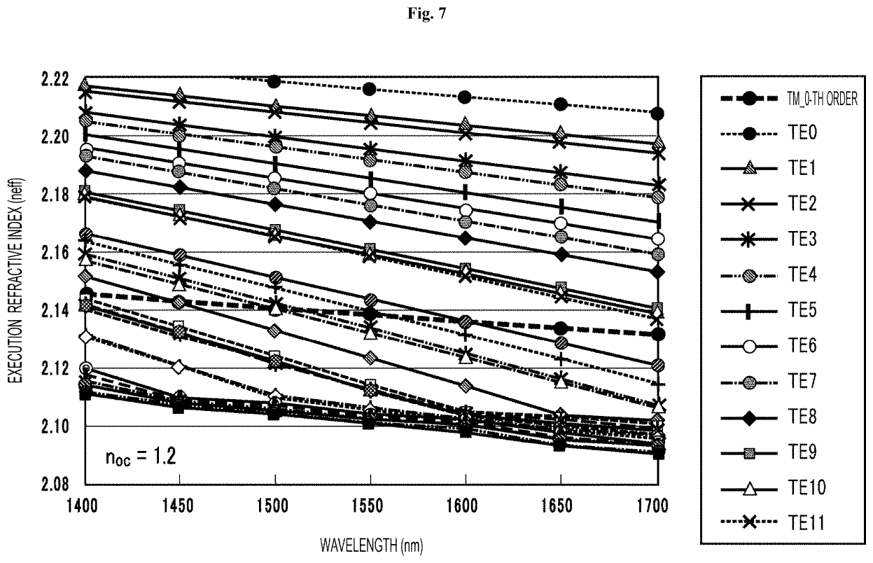

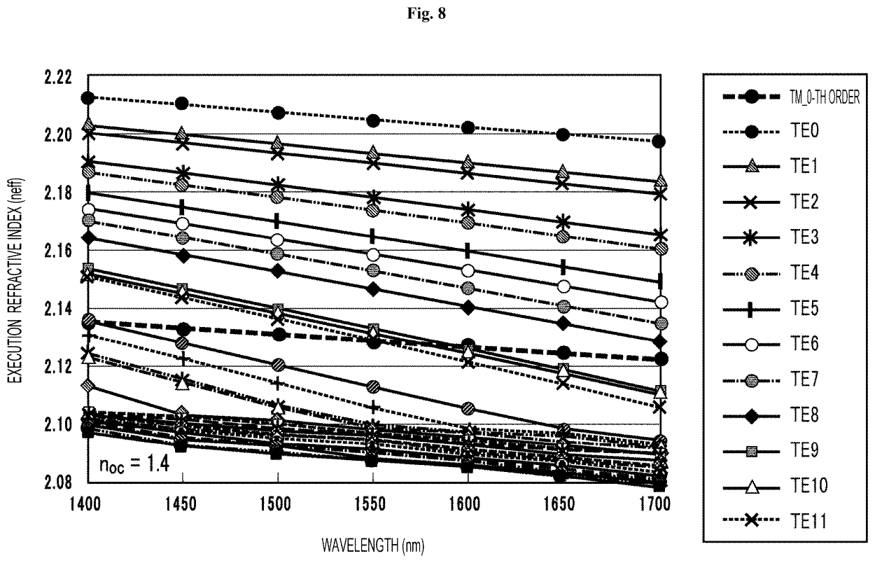

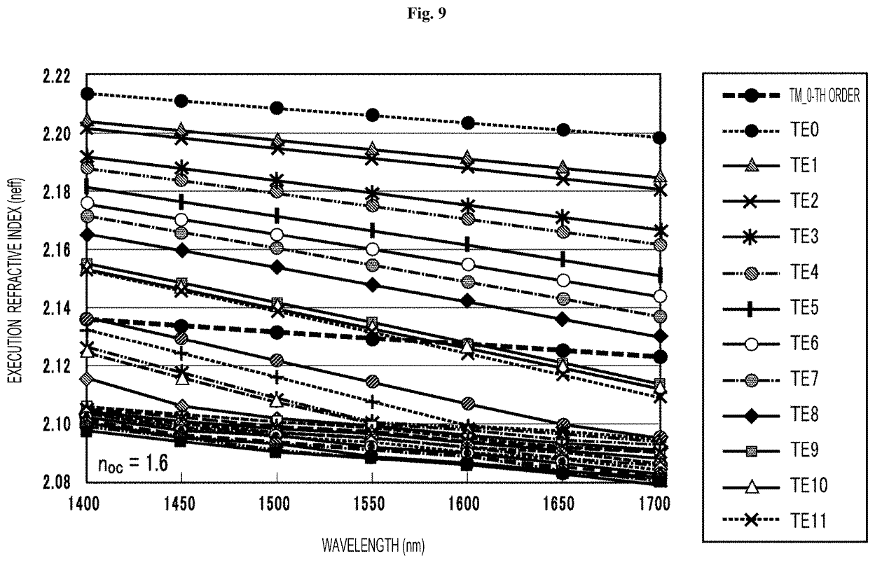

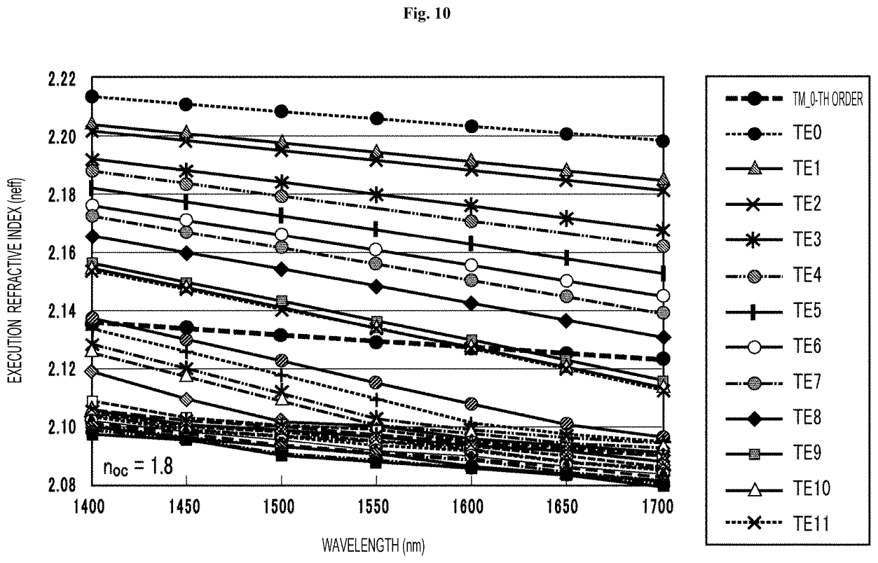

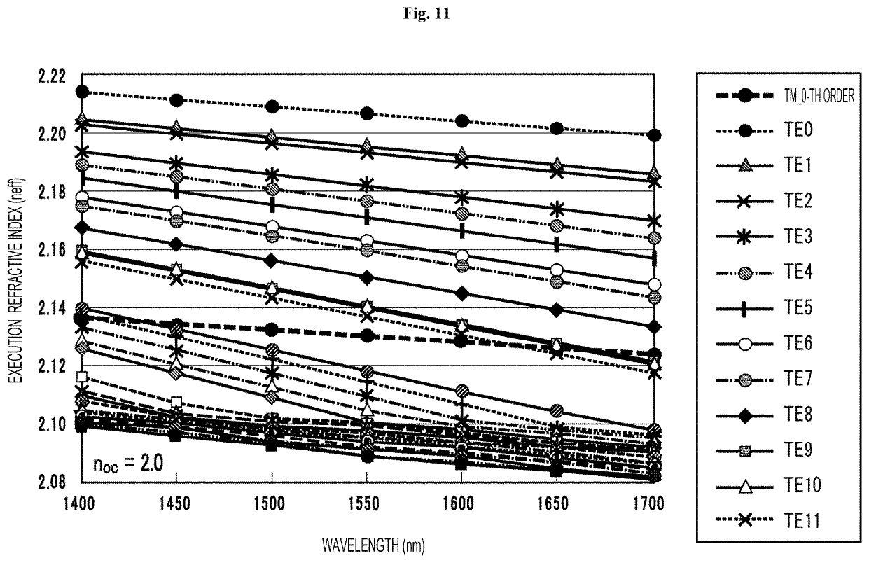

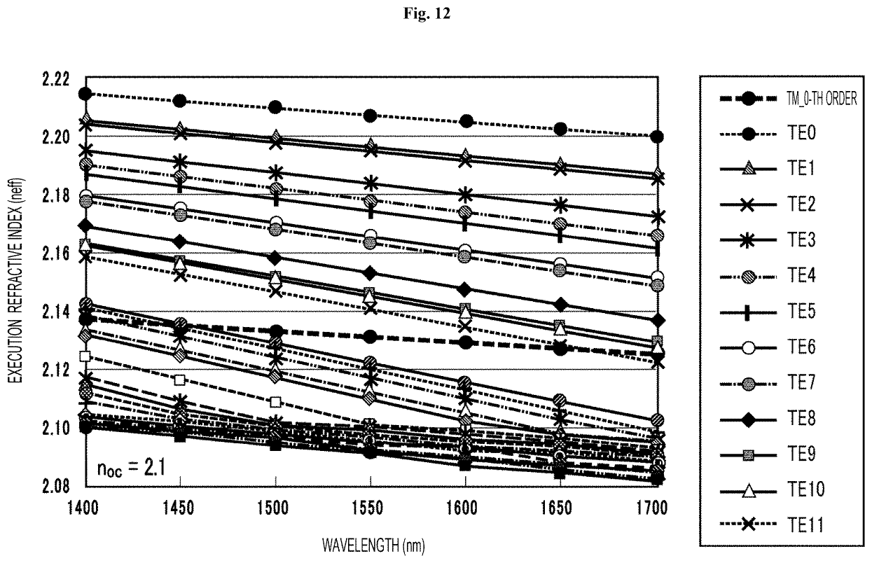

FIGS. 6 to 12 are graphs illustrating the effective refractive index of the propagation mode of each of TE polarization and TM polarization at the optical wavelength of 1400 nm to 1700 nm when the effective refractive index n_{OC} of overcladding is 1.0, 1.2, 1.4, 1.6, 1.8, 2.0, or 2.1. At this time, the combination of the broken line having a relatively large pitch and ● (dot) indicates the effective refractive index of the TM polarized 0th-order (basic) mode and corresponds to the effective refractive index of the signal light. FIGS. 6 to 11 illustrate the optical wavelength dependency of the effective refractive index of each higher-order mode of the TE polarization, except for the optical wavelength dependency of the 0th-order mode of the TM optical mode. As illustrated in FIGS. 6 to 12, in the vicinity of the intersection of the effective refractive indexes of the TM 0th-order mode and the TE higher-order mode, optical energy conversion of the TE mode light and the TM mode light occurs due to perturbation of the propagation mode of the optical waveguide, and the TE-TM conversion loss occurs. That is, the intersection of the effective refractive indexes of the TE mode light and the TM mode light is the optical wavelength of the TE-TM conversion loss.

As a result, as the refractive index n_{OC} of the overcladding increases from 1.0 toward 2.1 near the core refractive index, a wavelength band having no intersection, that is, a wavelength band in which no TE-TM conversion occurs, spreads.

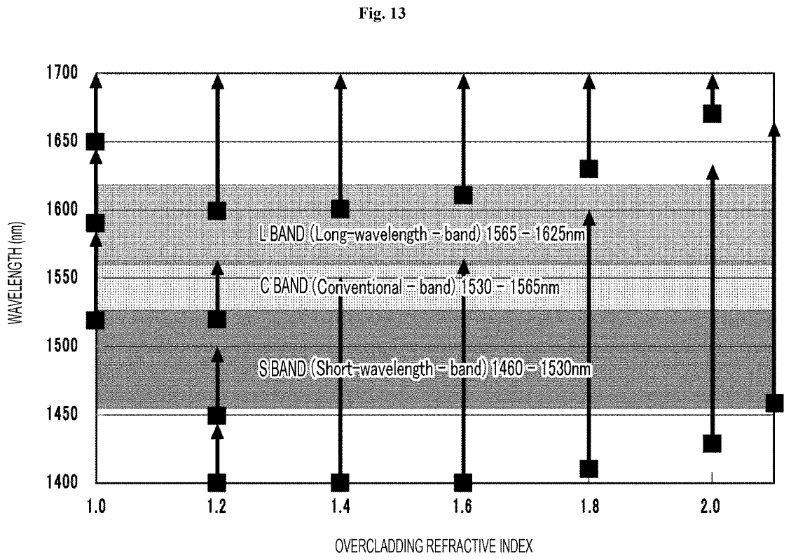

FIG. 13 illustrates a long wavelength side by ▴ (triangle) and a short wavelength side by ▪ (square) of a region having an intersection of the TM propagation 0th-order mode and the TE propagation mode having the wavelengths at which the TE-TM conversion loss occurs. That is, the solid line region in FIG. 13 is the region in which the TE-TM conversion loss does not occur. FIG. 13 also illustrates the S-band, C-band, and L-band wavelength bands used in the optical communication.

From FIG. 13, in order to enable use of the wavelength conversion element of the present example in the entire C band, it is necessary that the refractive index n_{OC} of the overcladding be larger than 1.6, that is, the refractive index be smaller than the effective refractive index of the optical waveguide core by 0% to 25%. Further, in order to enable use the wavelength conversion element in all the wavelength bands of the S band, the C band, and the L band, it is necessary that the refractive index n_{OC} of the overcladding be larger than 2.0, that is, the refractive index be smaller than the effective refractive index of the optical waveguide core by 0% to 6%. As described above, according to the present example, it has been found that the overcladding formation and the refractive index control are necessary for widening the optical wavelength of the wavelength conversion element.

### REFERENCE SIGNS LIST

1a Signal light
1b Control light
1c Difference frequency light
10 Basic Configuration
11 Optical waveguide core
11a Upper surface
11b Side surface
11c Cross section
12 Substrate
12a Upper surface
13 Wavelength conversion element
14 Multiplexer
15 Demultiplexer
20 Wavelength converter
26 Temperature control element
27 Support member
28 Metal housing bottom surface member
29 Cover member
101 Substrate
103 Optical waveguide core
301 Overcladding

1. A wavelength converter that receives signal light and generates light having a wavelength different from a wavelength of the signal light, the wavelength converter comprising:
a wavelength conversion element that includes an optical waveguide core and a substrate having a refractive index lower than the optical waveguide core with respect to the signal light and converts the wavelength of the signal light;
an overcladding layer formed on at least a part of a surface of the optical waveguide core and having a refractive index lower than the optical waveguide core with respect to optical wavelengths of the signal light and control light multiplexed with the signal light; and
a temperature control element that controls a temperature of the wavelength conversion element.

2. The wavelength converter according to claim 1, wherein the refractive index of the overcladding layer is in a range of 0% or more and 25% or less lower than the refractive index of the optical waveguide core.

3. The wavelength converter according to claim 1, wherein the overcladding layer contains lithium niobate (LiNbO₃), potassium niobate (KNbO₃), lithium tantalate (LiTaO₃), lithium tantalate having a non-stoichiometric composition (LiNb(x)Ta(1−x)O₃(0≤x≤1)), or potassium phosphate titanate (KTiOPO₄), further, zirconium (Zr), magnesium (Mg), zinc (Zn), scandium (Sc), or indium (In), or at least one oxide selected from zirconium (Zr), niobium (Nb), tantalum (Ta), hafnium (Hf), magnesium (Mg), zinc (Zn), scandium (Sc), titanium (Ti), yttrium (Y), aluminum (Al), indium (In), or silicon (Si), or
a polyolefin such as a polyethylene, a polypropylene, or a polybutylene, a polydiene such as a polybutadiene or natural rubber, a vinyl polymer such as a polystyrene, a polyvinyl acetate, a polymethyl vinyl ether, a polyethyl vinyl ether, a polyacrylic acid, a polymethyl acrylate, a polymethacrylic acid, a polymethyl methacrylate, a polybutyl methacrylate, a polyhexyl methacrylate, or a polydodecyl methacrylate, a linear olefin-based polyether, a polyphenylene oxide (PPO), or a copolymer or a blend thereof, a polyethersulfone (PES) in which an ether group and a sulfone group are mixed, a polyetherketone (PEK) in which an ether group and a carbonyl group are mixed, a polyether such as a polyphenylene sulfide (PPS) or a polysulfone (PSO) having a thioether group, or a copolymer or a blend thereof, a polyolefin having at least one substituent such as an OH group, a thiol group, a carbonyl group, or a halogen group at a terminal, an epoxy resin, a crosslinked product by an oligomer and a curing agent, or a mixture obtained by mixing two or more kinds of the above materials.

4. The wavelength converter according to claim 1, wherein lithium niobate (LiNbO₃) is used for the optical waveguide core and lithium tantalate (LiTaO₃) is used for the substrate, and the overcladding layer is provided on the surface of the optical waveguide core, the overcladding layer having the refractive index in a range of 0% or more and 25% or less lower than the optical waveguide core in the optical wavelengths of the signal light and the control light.
